(19) United States
(12) Patent Application Publication
(10) Pub. No.: US 2007/0022250 A1
(43) Pub. Date: Jan. 25, 2007

(54) System and method of responding to a cache read error with a temporary cache directory column delete

(75) Inventors: James Stephen Fields JR., Austin, TX (US); Guy Lynn Guthrie, Austin, TX (US); William John Starke, Round Rock, TX (US); Phillip G. Williams, Leander, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/184,343

(22) Filed: Jul. 19, 2005

(51) Int. Cl. G06F 12/00

(52) U.S. Cl. 711/133

(57) ABSTRACT

A system and method of responding to a cache read error with a temporary cache directory column delete. A read command is received at a cache controller. In response to determining that data requested by said read command is stored in a specific data location in the cache, a read of the data is initiated. In response to determining the read of said data results in an error, a column delete indicator for an associativity class including a specific data location to temporarily prevent allocation within the associativity class of storage locations is set. A specific line delete command that marks the specific data location as deleted is issued. In response to the issuing of the specific line delete command, the column delete indicator for the associativity class, such that storage locations within the associativity class other than the specific data location can again be allocated to hold new data is set.

### BACKGROUND OF THE INVENTION

1. Technical Field

The present invention relates in general to the field of data processing systems. Still more specifically, the present invention relates to a system and method of controlling a memory hierarchy in a data processing system.

2. Description of the Related Art

A conventional multi-processor data processing system (referred hereinafter as an MP), typically includes a system memory, input/output (I/O) devices, multiple processing elements that each include a processor and one or more levels of high-speed cache memory, and a system bus coupling the processing elements to each other and to the system memory and I/O devices. The processors all utilize common instruction sets and communication protocols, have similar hardware architectures, and are generally provided with similar memory hierarchies.

Caches are commonly utilized to temporarily store values that might be accessed by a processor in order to speed up processing by reducing access latency as compared to loading needed values from memory. Each cache includes a cache array and a cache directory. An associated cache controller manages the transfer of data and instructions between the processor core or system memory and the cache. Typically, the cache directory also contains a series of bits utilized to track the coherency states of the data in the cache.

With multiple caches within the memory hierarchy, coherency is maintained through the utilization of a coherency protocol, such as the MESI protocol. In the MESI protocol, an indication of a coherency state is stored in association with each coherency granule (e.g., a cache line or sector) of one or more levels of cache memories. Each coherency granule can have one of the four MESI states, which is indicated by bits in the cache directory.

The MESI protocol allows a cache line of data to be tagged with one of four states: “M” (modified), “E” (exclusive), “S” (shared), or “I” (invalid). The Modified state indicates that a coherency granule is valid only in the cache storing the modified coherency granule and that the value of the modified coherency granule has not been written to system memory. When a coherency granule is indicated as Exclusive, only that cache holds the data, of all the caches at that level of the memory hierarchy. However, the data in the Exclusive state is consistent with system memory. If a coherency granule is marked as Shared in a cache directory, the coherency granule is resident in the associated cache and possibly in at least one other, and all of the copies of the coherency granule are consistent with system memory. Finally, the Invalid state indicates that the data and address tag associated with a coherency granule are both invalid.

The state to which each coherency granule (e.g., cache line or sector) is set is dependent upon both a previous state of the data within the cache line and the type of memory access request received from a requesting device (e.g., a processor). Accordingly, maintaining memory coherency in the MP requires that the processors communicate messages across the system bus indicating their intention to read or write to memory locations. For example, when a processor desires to write data to a memory location, the processor must first inform all other processing elements of its intention to write data to the memory location and receive permission from all other processing elements to carry out the write operation. The permission messages received by the requesting processor indicate that all other cached copies of the contents of the memory location have been invalidated, thereby guaranteeing that the other processors will not access their stale local data.

In some MP systems, the cache hierarchy includes two or more levels. The level one (L1) cache is usually a private cache associated with a particular processor core in the MP system. The processor first looks for data in the level one cache. If the requested data block is not in the level one cache, the processor core then accesses the level two cache. This process continues until the final level of cache is referenced before accessing main memory. Some of the cache levels (e.g., the level three or L3 cache) may be shared by multiple caches at the lower level (e.g., L3 cache may be shared by multiple L2 caches). Generally, the size of a cache increases as its level increases, but its speed decreases accordingly. Therefore, it is advantageous for system performance to keep data at upper levels of the cache hierarchy whenever possible.

Like all components of a data processing system, cache memories periodically fail. Sometimes, these cache failures occur gradually in the cache, starting with a few memory blocks. When a data processing system component, such as a processor requests data stored in a cache memory with failing memory blocks, processor cycles are wasted because some of the memory blocks are not accessible or require the handling of access errors. Therefore, there is a need for a system and method of handling failing cache memory blocks within memory hierarchies.

### SUMMARY OF THE INVENTION

As disclosed, the present invention includes a system and method of responding to a cache read error with a temporary cache directory column delete. A read command is received at a cache controller. In response to determining that data requested by said read command is stored in a specific data location in the cache, a read of the data is initiated. In response to determining the read of said data results in an error, a column delete indicator for an associativity class including a specific data location to temporarily prevent allocation within the associativity class of storage locations is set. A specific line delete command that marks the specific data location as deleted is issued. In response to the issuing of the specific line delete command, the column delete indicator for the associativity class is reset, such that storage locations within the associativity class other than the specific data location can again be allocated to hold new data.

The above-mentioned features, as well as additional objectives, features, and advantages of the present invention will become apparent in the following detailed description.

### BRIEF DESCRIPTION OF THE FIGURES

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 illustrates a block diagram of an exemplary data processing system in which a preferred embodiment of the present invention may be implemented;

FIG. 2 depicts a more detailed block diagram of an exemplary processing unit in which a preferred embodiment of the present invention may be implemented;

FIG. 3 illustrates a more detailed block diagram of an exemplary cache controller in which a preferred embodiment of the present invention may be implemented; and

FIG. 4 is a high-level logical flowchart diagram depicting an exemplary method of handling a cache read error with a temporary cache directory column delete according to preferred embodiment of the present invention.

### DETAILED DESCRIPTION OF A PREFERRED EMBODIMENT

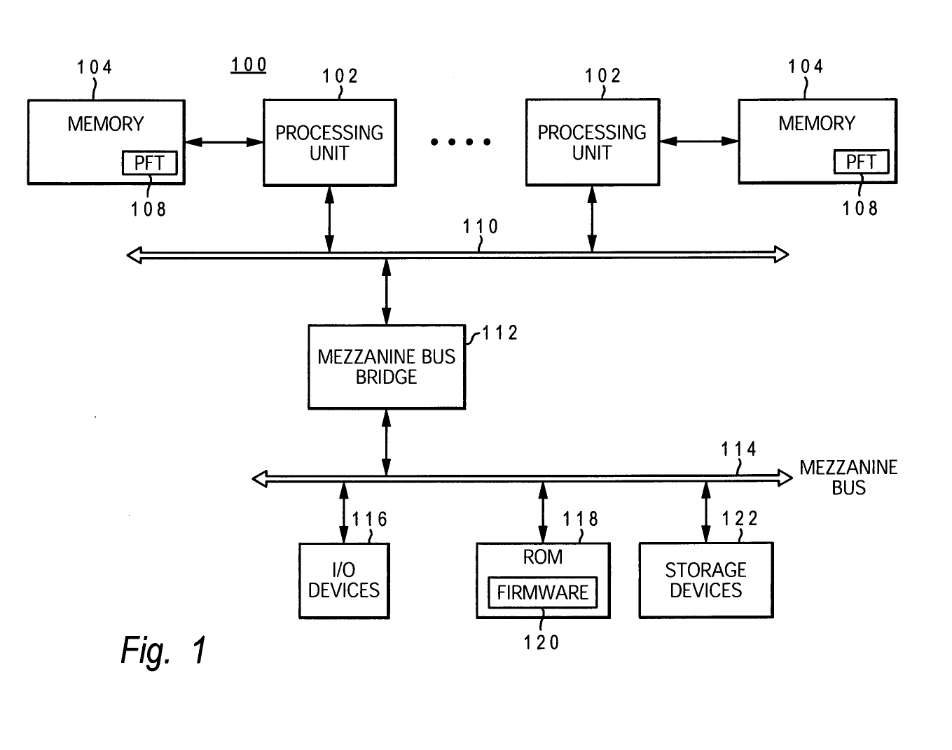

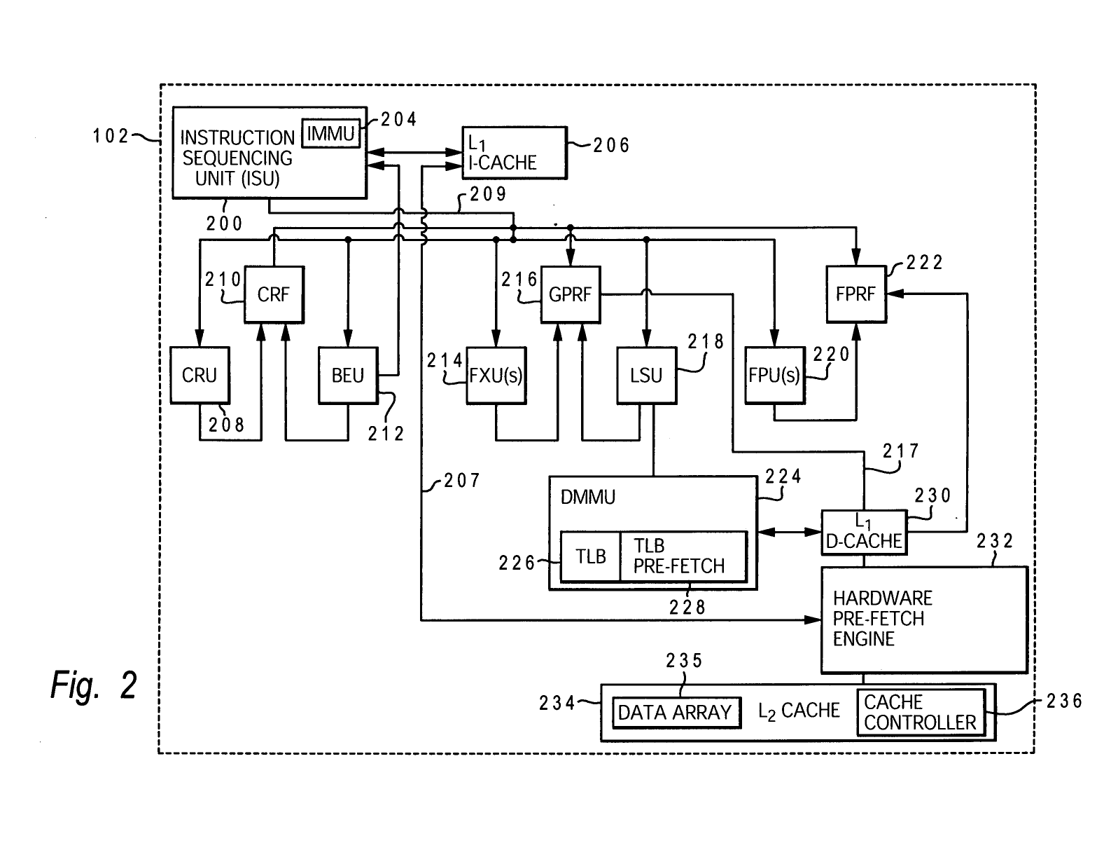

Referring now to FIG. 1 there is depicted a block diagram of a multi-procesor data processing system 100 in which a preferred embodiment of the present invention may be implemented. As illustrated, multi-processor data processing system 100 includes multiple processing units 102, which are each coupled to a respective one of memories 104. Each processing unit is further coupled to an interconnection 110 that supports the communication of data, instructions, and control information between processing units 102. Each processing unit is preferably implemented as a single integrated circuit comprising a semiconductor substrate having integrated circuitry formed thereon. Multiple processing units 102 and at least a portion of interconnect 110 may advantageously be packaged together on a common backplane or chip carrier. Page frame tables (PFTs) 108, implemented in memories 104, hold a collection of page table entries (PTEs). The PTEs in PFTs 108 are accessed to translate effective addresses (EAs) employed by software executed within processing units 202 into physical addresses (PAs), as discussed in greater detail below with reference to FIG. 2.

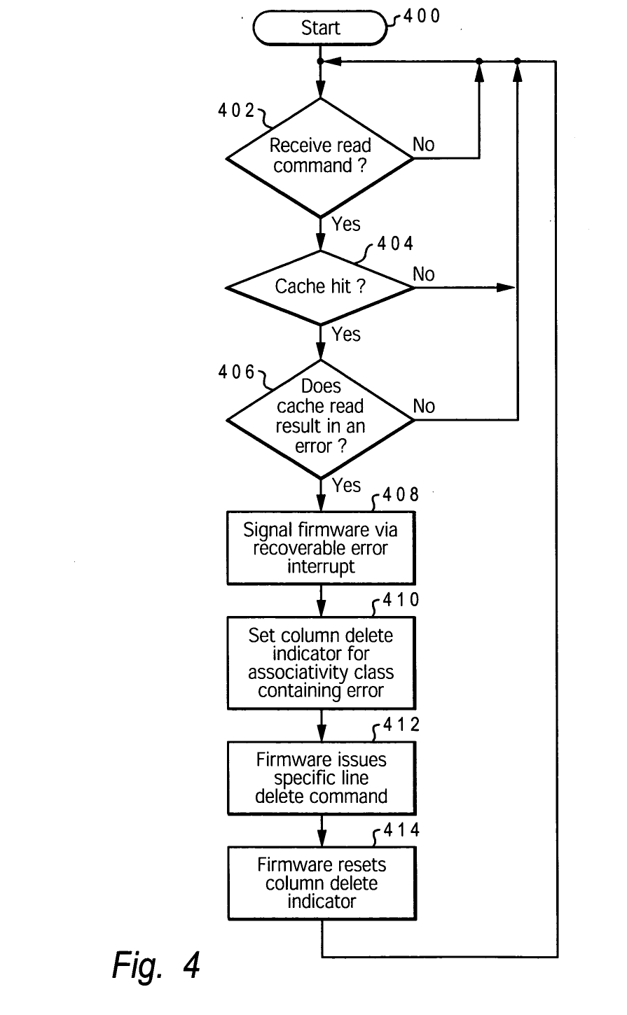

Interconnect 110 is coupled to a mezzanine bus 114 via mezzanine bus bridge 112. Mezzanine bus 114 supports a collection of I/O devices 116, a read-only memory (ROM) 118, and a collection of storage devices 122. ROM 118 also includes firmware 120. As discussed herein in more detail in conjunction with FIG. 4, firmware 120 includes a set of instructions to regulate system processes including, but not limited to, the control of storage devices 122, I/O devices 116, and responding to cache memory read failures by marking defective cache memory locations.

Those skilled in the art will appreciate that multi-processor (MP) data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to cache operation provided by the present invention are applicable to data processing systems of any system architecture and are in no way limited to the generalized MP architecture or symmetric multi-processor (SMP) system structure illustrated in FIG. 1.

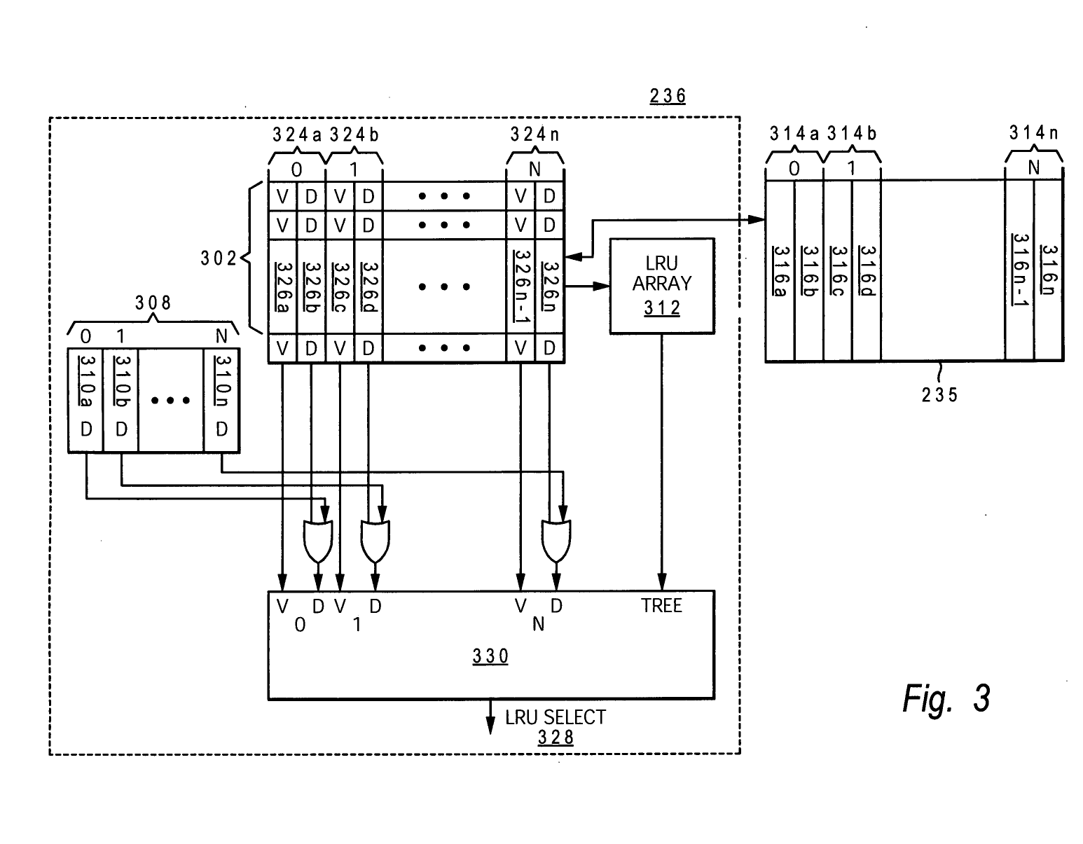

With reference now to FIG. 2, there is illustrated a detailed block diagram of an exemplary embodiment of a processing unit 102 in accordance with the present invention. As shown, processing unit 102 contains an instruction pipeline including an instruction sequencing unit (ISU) 200 and a number of execution units 208, 212, 214, 218, and 220. ISU 200 fetches instructions for processing from an L1 I-cache 206 utilizing real addresses obtained by the effective-to-real address translation (ERAT) performed by instruction memory management unit (IMMU) 204. Of course, if the requested cache line of instructions does not reside in L1 I-cache 206, then ISU 200 requests the relevant cache line of instructions from L2 cache 234 via I-cache reload bus 207, which is also coupled to hardware pre-fetch engine 232. L2 cache 234 also includes a data array 235 and a cache controller 236, which is discussed herein in more detail in conjunction with FIG. 3.

After instructions are fetched and preprocessing, if any, is performed, ISU 200 dispatches instructions, possibly out-of-order, to execution units 208, 212, 214, 218, and 220 via instruction bus 209 based upon instruction type. That is, condition-register-modifying instructions and branch instructions are dispatched to condition register unit (CRU) 208 and branch execution unit (BEU) 212, respectively, fixed-point and load/store instructions are dispatched to fixed-point unit(s) (FXUs) 214 and load-store unit(s) (LSUs) 218, respectively, and floating-point instructions are dispatched to floating-point unit(s) (FPUs) 220.

After possible queuing and buffering, the instructions dispatched by ISU 200 are executed opportunistically by execution units 208, 212, 214, 218, and 220. Instruction “execution” is defined herein as the process by which logic circuits of a processor examine an instruction operation code (opcode) and associated operands, if any and in response, move data or instructions in the data processing system (e.g., between system memory locations, between registers or buffers and memory, etc.) or perform logical or mathematical operations on the data. For memory access (i.e., load-type or store-type) instructions, execution typically includes calculation of a target effective address (EA) from instruction operands.

During execution within one of execution units 208, 212, 214, 218, and 220, an instruction may receive input operands, if any, from one or more architected and/or rename registers within a register file coupled to the execution unit. Data results of instruction execution (i.e., destination operands), if any, are similarly written to instruction-specified locations within the register files by execution units 208, 212, 214, 218, and 220. For example, FXU 214 receives input operands from and stores destination operands (i.e., data results) to a general-purpose register file (GPRF) 216, FPU 220 receives input operands from and stores destination operands to a floating-point register file (FPRF) 222, and LSU 218 receives input operands from GPRF 216 and causes data to be transferred between L1 D-cache 230 (via interconnect 217) and both GPRF 216 and FPRF 222. Similarly, when executing condition-register-modifying or condition-register-dependent instructions, CRU 208 and BEU 212 access control register file (CRF) 210, which in a preferred embodiment includes a condition register, link register, count register, and rename registers of each. BEU 212 accesses the values of the condition, link and count registers to resolve conditional branches to obtain a path address, which BEU 212 supplies to instruction sequencing unit 200 to initiate instruction fetching along the indicated path. After an execution unit finishes execution of an instruction, the execution unit notifies instruction sequencing unit 200, which schedules completion of instructions in program order and the commitment of data results, if any, to the architected state of processing unit 202.

Still referring to FIG. 2, a preferred embodiment of the present invention preferably includes a data memory management unit (DMMU) 224. DMMU 224 translates effective addresses (EA) in program-initiated load and store operations received from LSU 218 into physical addresses (PA) utilized to access the volatile memory hierarchy comprising L1 D-cache 230, L2 cache 234, and system memories 104. DMMU 224 includes a translation lookaside buffer (TLB) 226 and a TLB pre-fetch engine 228.

TLB 226 buffers copies of a subset of Page Table Entries (PTEs), which are utilized to translate effective addresses (EAs) employed by software executing within processing units 102 into physical addresses (PAs). As utilized herein, an effective address (EA) is defined as an address that identifies a memory storage location or other resource mapped to a virtual address space. A physical address (PA), on the other hand, is defined herein as an address within a physical address space that identifies a real memory storage location or other real resource.

TLB pre-fetch engine 228 examines TLB 226 to determine the recent translations needed by LSU 218 and to speculatively retrieve into TLB 226 PTEs from PFT 108 that may be needed for future transactions. By doing so, TLB pre-fetch engine 228 eliminates the substantial memory access latency associated with TLB misses that are avoided through speculation.

FIG. 3 is a more detailed block diagram of an exemplary L2 cache 234 according to a preferred embodiment of the present invention. Although not depicted, those with skill in this art will appreciate that L1 I-cache 206 and L1 D-cache 230 may be similarly constructed. Those skilled in the art will also appreciate that L2 cache controller 234 can include many additional components not specifically illustrated in FIG. 3. Because such additional components are not necessary for an understanding of the present invention, they are not illustrated in FIG. 3 or discussed further herein.

L2 cache 234 includes a data array 235 which includes a collection of associativity classes 314a-n. Each associativity class 314a-n includes at least one cache line 316a-n. As illustrated, L2 cache 234 further includes a cache controller 236 having a cache directory 302, least recently used (LRU) array 312, column delete register 308, and multiplexor 330. As discussed herein in more detail, these components are utilized by cache controller 236 during the processing of commands issued from ISU 300.

Cache directory 302 identifies the current contents of data array 235. Cache directory 302 includes a collection of associativity class entries 324a-n that respectively correspond to the associativity classes 314a-n located in L2 cache 234. Each cache line entry 326a-n in cache directory 302 describes the data stored in the corresponding cache line locations and whether the stored data is Modified, Exclusive, Shared, or Invalid. As illustrated cache line entries 326a-n also include indications of whether the lines are “valid” or “deleted”. In a preferred embodiment of the present invention, a cache line or associativity class is disabled or marked as “deleted” if a cache access to that particular cache line or associativity class results in a cache read error. Consequently, the cache line or associativity class has a “valid” indication when the location is currently occupied with a valid cache line. When the cache line or associativity class is not marked as “deleted”, the physical location is enabled and has not generated errors. The marking of memory locations with “valid” or “deleted” markings will be discussed herein in more detail in conjunction with FIG. 4.

Column delete register 308 includes column entries 310a-n, which correspond to associativity classes 314a-n and associativity class entries 324a-n. Each column entry 310a-n includes indications of whether the entire associativity class 314a-n is “available to be used” or “deleted”. During operation of data processing system 100, a data read error occurs for a specific cache line, such as cache line 316a, cache controller 236 sets a column entry, such as column entry 310a, corresponding to the associativity lass 314a that includes cache line 316a, which generated the read error. Setting the column entry 310a prevents data from being stored in that associativity class 314a. This process will be discussed later in more detail in conjunction with FIG. 4.

Referring now to FIG. 4, there is illustrated a high-level logical flowchart diagram depicting an exemplary method of implementing a temporary cache directory column delete according to a preferred embodiment of the present invention. The process begins at step 400 and proceeds to step 402. For example, ISU 200 (or any data processing system component that would access L2 cache 234) issues a data read command to cache controller 236. ISU 200 requests data that may or may not be stored in L2 cache 234. If cache controller 236 has not received a read command from ISU 200, the process iterates at step 402. As shown in step 404, cache controller 236 searches cache directory 302 for an entry that represents the requested data (e.g., cache hit). For example, if requested data is stored in cache line 316a, an entry 326a will exist in cache directory 302 and the process will continue to step 406. However, if an entry 326a does not exist in cache directory 302, the requested data is not stored in L2 cache 234 and the process returns to step 402.

As show in step 406, cache controller 236 determines whether the execution of a read command to cache line 316a results in a cache read error. If the execution of a read command to cache line 316a does not result in a cache read error, the process returns to step 402 and proceeds in an iterative fashion. However, if the execution of a read command to cache line 316a results in a cache read error, the process continues to step 408.

The next sequence involves cache controller 236 communicating with firmware 120. Because firmware 120 requires many processor cycles to identify and mark any problem cache lines, the present invention provides an exemplary method of preventing future cache writes to a problem cache line. As shown in step 408, cache controller 236 sends a notification to firmware 120 indicating the cache read error and the particular cache line that generated the error.

As illustrated in step 410, cache controller 236 sets a column delete indicator for the associativity class that included the cache line that generated the cache read error. For example, if a cache read attempt to cache line 316a resulted in a cache read error, cache controller 236 will set column delete indicator entry 310a to “deleted” to temporarily prevent future data stores to associativity class 314a until firmware 120 issues a specific delete command to specifically mark cache line 316a as deleted.

Step 412 depicts firmware 120 issuing a specific line delete command to cache line 316a by setting the “deleted” indicator in directory entry 326a. This command specifically targets cache line 316a and marks it as “deleted” which labels it as a “problem” cache line to prevent future data stores. Now that the specific cache line 316a has been marked as “deleted”, the process continues to step 414, which illustrates firmware 120 resetting column delete indicator 310a as “valid”, which enables associativity class 314a to be selected by multiplexor 330 for future data stores to L2 cache 234. The process then returns to step 402 and proceeds in an iterative fashion.

As disclosed, the present invention includes a system and method of responding to a cache read error with a temporary cache directory column delete. A read command is received at a cache controller. In response to determining that data requested by said read command is stored in a specific data location in the cache, a read of the data is initiated. In response to determining the read of said data results in an error, a column delete indicator for an associativity class including a specific data location to temporarily prevent allocation within the associativity class of storage locations is set. A specific line delete command that marks the specific data location as deleted is issued. In response to the issuing of the specific line delete command, the column delete indicator for the associativity class, such that storage locations within the associativity class other than the specific data location can again be allocated to hold new data is set.

Also, it should be understood that at least some aspects of the present invention may alternatively be implemented in a computer-readable medium that stores a program product. Programs defining functions in the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore, such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
receiving a read command at a cache controller;
in response to determining said data requested by said read command is stored in a specific data location in said cache, initiating a read of said data;
in response to determining said read of said data results in an error, setting a column delete indicator for an associativity class including said specific data location to temporarily prevent allocation within said associativity class of storage locations;
issuing a specific line delete command that marks said specific data location as deleted; and
in response to said issuing said specific line delete command, resetting said column delete indicator for said associativity class, such that storage locations within said associativity class other than said specific data location can again be allocated to hold new data.

2. The method according to claim 1 further comprising:
sending a notification to firmware indicating a cache read error and said specific data location that generated said error.

3. The method according to claim 2, wherein said notification to firmware is sent via a recoverable error interrupt.

4. The method according to claim 1, wherein said resetting further comprises:
removing said deleted marking.

5. A processing unit comprising:
at least one processor;
a cache hierarchy, coupled to said at least one processor;
a cache controller, coupled to said cache hierarchy, said cache controller for temporarily setting a column delete indicator for an associativity class including a specific data location in said cache hierarchy to temporarily prevent allocation within said associativity class of storage locations, in response to determining that a read of data stored in said specific data location results in a data read error; and
a memory, coupled to said processing unit, said memory further comprises firmware for regulating system processes, wherein said firmware issues a specific line delete command that marks said specific data location as deleted and in response to said issuing said specific line delete command, said firmware resets said column delete indicator for said associativity class, such that storage locations within said associativity class other than said specific data location can again be allocated to hold new data.

6. The processing unit according to claim 5, wherein said cache controller sends a notification to firmware indicating a cache read error and said specific data location that generated said error.

7. The processing unit according to claim 6, wherein said notification to firmware is sent via a recoverable error interrupt.

8. The processing unit according to claim 5, wherein said firmware removes said deleted marking.

9. A data processing system comprising:
at least one processing unit according to claim 5; and
a system memory.

10. A computer-readable medium, storing a computer program product comprising instructions for:
receiving a read command at a cache controller;
in response to determining said data requested by said read command is stored in a specific data location in said cache, initiating a read of said data;
in response to determining said read of said data results in an error, setting a column delete indicator for an associativity class including said specific data location to temporarily prevent allocation within said associativity class of storage locations;
issuing a specific line delete command that marks said specific data location as deleted; and
in response to said issuing said specific line delete command, resetting said column delete indicator for said associativity class, such that storage locations within said associativity class other than said specific data location can again be allocated to hold new data.

11. The computer-readable medium according to claim 10, wherein said computer program product further comprises instructions for:
sending a notification to firmware indicating a cache read error and said specific data location that generated said error.

12. The computer-readable medium according to claim 11, wherein said computer program product further comprises instructions for:
sending said notification via a recoverable error interrupt.

13. The computer-readable medium according to claim 10, wherein said computer program product further comprises instructions for:
removing said deleted marking.
